(19) United States
(12) Patent Application Publication
(10) Pub. No.: US 2017/0059132 A1
(43) Pub. Date: Mar. 2, 2017

(54) LED bulb has multiple features

(71) Applicant: Tseng-Lu Chien, Walnut, CA (US)

(72) Inventor: Tseng-Lu Chien, Walnut, CA (US)

(21) Appl. No.: 15/348,218

(22) Filed: Nov. 10, 2016

Related U.S. Application Data
(63) Continuation-in-part of application No. 14/289,968, filed on May 29, 2014.
Application No. 14/289,968 is a division of application No. 14/280,865, filed on May 19, 2014.
Application No. 14/280,865 is a division of application No. 13/540,728, filed on Jul. 3, 2012, now Pat. No. 8,834,009.
Application No. 13/540,728 is a continuation-in-part of application No. 14/503,647, filed on Oct. 1, 2014.
Application No. 14/503,647 is a continuation-in-part of application No. 14/323,318, filed on Jul. 3, 2014.
Application No. 14/323,318 is a continuation-in-part of application No. 14/606,242, filed on Jan. 27, 2015, now Pat. No. 9,541,260.
Application No. 14/606,242 is a continuation-in-part of application No. 13/367,758, filed on Feb. 7, 2012, now Pat. No. 8,967,831.
Application No. 13/367,758 is a continuation-in-part of application No. 14/983,993, filed on Dec. 30, 2015.
Application No. 14/983,993 is a continuation-in-part of application No. 15/170,071, filed on Jun. 1, 2016.
Application No. 15/170,071 is a continuation-in-part of application No. 14/844,314, filed on Sep. 3, 2015.
Application No. 14/844,314 is a continuation of application No. 12/938,564, filed on Nov. 3, 2010, now Pat. No. 9,239,513.
Application No. 12/938,564 is a continuation-in-part of application No. 15/296,599, filed on Oct. 18, 2016.
Application No. 15/296,599 is a continuation of application No. 14/503,647, filed on Oct. 1, 2014.
Application No. 14/503,647 is a division of application No. 14/451,822, filed on Aug. 5, 2014.
Application No. 14/451,822 is a continuation-in-part of application No. 14/323,318, filed on Jul. 3, 2014.
Application No. 14/323,318 is a continuation-in-part of application No. 14/023,889, filed on Sep. 11, 2013.
Application No. 14/023,889 is a continuation of application No. 13/540,728, filed on Jul. 3, 2012, now Pat. No. 8,834,009.
Application No. 13/540,728 is a continuation-in-part of application No. 13/296,508, filed on Nov. 15, 2011, now Pat. No. 8,562,158.
Application No. 13/296,508 is a continuation-in-part of application No. 13/296,469, filed on Nov. 15, 2011, now Pat. No. 8,711,216.

(51) Int. Cl. F21V 14/00; F21V 29/502; F21S 10/00; F21V 23/04; F21S 8/00; F21K 9/232

(52) U.S. Cl. CPC F21V 14/006; F21S 8/035; F21K 9/232; F21S 10/00; F21V 23/0442; F21V 29/502; F21Y 2115/10

(57) ABSTRACT

The current invention make a big improvement than conventional market available all kind of LED bulb which only can offer near-by areas illumination not like the current invention can use one LED bulb to offer near-by and far-away illumination or image or both or any combination with other light effects and digital data display images. Also, The current invention may has more than one light beam emit out from LED bulb which under more than one control means for the one of the light beam may selected from power failure, remote control, Infra red controller, blue-tooth with mobile phone, motion sensor to trigger at least one of the light beam to offer the light beam for illumination or image to area(s).

This application is a continuation of U.S. patent application Ser. No. 13/540,728, filed Jul. 3, 2012, now allowed, which is a continuation-in-part of U.S. patent application Ser. Nos. 13/296,508, now U.S. Pat. No. 8,562,158, and 13/296,469, now U.S. Pat. No. 8,711,216, each filed Nov. 15, 2011 and incorporated herein by reference.

### BACKGROUND OF THE INVENTION

The present application has subject matter in common with copending and patented applications of the inventor that are directed to (1) a projection light, (2) a device with more than one function, (3) an adjustable focus device, (4) an adjustable angle device, (5) elastic contact points, (6) an LED heat solution, (7) installation of heat sensitive parts, and (8) extension means. The copending and patented applications include U.S. patent application Ser. Nos. 13/367,758, 13/367,687, 13/296,508, 13/296/469, 13/295,301, 13/021,107, 12/950,017, 12/951,501, 12/938,564, 12/886,832, 12/876,507, 12/771,003, 13/021,124, 12/624,621, 12/622,000, 12/318,470, 12/914,584, 12/834,435, 12/292,153, 12/907,443, 12/232,505, 11/806,711, and 11/806,285. US13/295,301 is for a h device having built-in digital data means and powered by an unlimited power source of the light device. U.S. patent application Ser. No. 13/296,508 is for a device having built-in digital data means and powered by an unlimited power source of an LED bulb. U.S. patent application Ser. No. 13/296,469 is for a device having built-in digital data means and powered by an unlimited power source of a lamp holder. Finally, U.S. patent application Ser. No. 12/951,501 is for a lamp holder having a built-in LED night light.

These applications are further related to the inventor's copending and patented U.S. patent application Ser. Nos. 13/162,824 (light device with display means, track-means, and removable LED-unit(s)), 12/938,628 (LED light fixture has outlet(s) and removable LED unit(s)), 12/887,700 (light fixture with self-powered removable LED unit(s)), 12/149,963 (now U.S. Pat. No. 7,722,230), 12/073,095 (now U.S. Pat. No. 7,726,869), 12/073,889, 12/007,076 (now U.S. Pat. No. 7,726,841), 12/003,691 (now U.S. Pat. No. 7,726,839), and 12/894,865.

The above-listed patent applications are further related to the inventor's copending or patented U.S. patent application Ser. Nos. 12/624,621, 12/622,100, 12/318,471, 12/318,470, 12/318,473, 12/292,153, 12/232,505, 12/232,035, 12/149,963, 12/149,964, 12/073,095, 12/073,889, 12/007,076, 12/003,691, 12/003,809, 11/806,711, 11/806,285, 11/806,284, 11/566,322, 11/527,628, 11,527,629, 11/498,874, 12/545,992, 12/806,711, 12/806,285, 12/806,284, 12/566,322, 12/527,628, 12/527,629, 12/527,631, 12/502,661, 11/498,881, 11/255,981, 11/184,771, 11/152,063, 11/094,215, 11/092,742, 11/092,741, 11/094,156. 11/094,155. 10/954,189, 10/902,123,/10/883,719, 10/883,747, 10/341,519, 12/545,992, 12/292,580, 12/710,918, 12/624,621, 12/622,000, 12/318,471, 12/318,470, 12/318,473, 12/292,153, 12/710,561, 12/710,918, 12/711,456, and 12/771,003.

The current invention is an LED bulb that may incorporate features described in the above-listed copending or patented cases of the inventor as well as related or equivalent features, functions, or replacement parts. Additional features of the invention include the following:

1. The LED bulb has the property that the LED bulb can twisted over an additional degree or twist angle after the LED Bulb's contact-point touches an electrode in the holder, enabling horizontal positioning over an angle of more than 360 degrees when positioning a light beam to desired area(s) to obtain a wider adjustment angle or wider range of adjustment directions, and with the additional feature of incorporating an adjustable focus means to cause the LED light beams or image to provide different light performances on any desired locations or area(s). The LED bulb may include a rotatable LED Ball with two arms so that an LED bulb of preferable geometric shape and construction may also have a vertical adjustment angle of up to more than 360 degrees so that the LED bulb's plurality of light beams can cover all x-y-z axis areas by at least one of light beam or a plurality of the light beams and illuminate both nearby and faraway or remote areas.

2. The LED Bulb may have one or more than one light source arranged in the LED bulb to provide a desired light performance as described in the inventor's copending U.S. patent applications, which describe a night light with more than one LED light source or LED projection assembly. A difference with respect to the prior arrangements is that a night light has prong means for outlet installation and does not have extendable/retractable means.

3. The current invention includes an LED Bulb with adjustable focus means to enable light beams from the same LED bulb to be emitted to any desired surface(s) with a desired light performance, including a desired brightness, size, light spots, color, or lit-areas. The same light beam output from the same LED bulb with focus adjustable means enables a user to create different light patterns, light paths, light brightness, light performance, and light direction.

4. The LED bulb of the current invention has extendable means, such as an extension tube, telescope tube or equivalent extendable and receivable means that enable the electric parts and accessories of the LED bulb to keep away from the LED's heat, and away from any light blocking-means in the LED bulb, such as a curtain, shade, glass, recess lighting cylinder tube, or other blocking-means that would otherwise block a motion-sensor lens, remote control signal, or light beam emission direction, the extendable means further keeping the LED bulb's circuit board/control means/IC means/switch means/sensor means/electric parts or assembly means away from the LED-units to thereby prevent heat from affecting desired functions or performance, such as the performance of a motion sensor, PIR sensor head, Fresnel lens, or LED-unit light beam emitting direction.

5. The LED bulb of the current invention may have an extractable/extendable/movable means to put heat sensitive or light sensitive parts away from the LEDs' heat, light shade, curtain, glass, decorative material, ceiling blocking means, or any other light blocking means that might interfere with operation of the LED bulb or LED bulb's related parts and accessories. The extendable or extractable means preferably being situated at the front of the LED bulb, although the position will depend on the different requirements and different considerations with respect to heat and light blocking-means, and the ability to offer more space to install the preferred electric parts and accessories, the extra length provided by the extractable/extendable/movable means having the effect of moving sensitive parts far away from the heat source or blocking means so that the LED bulb can overcome the effects of heat and blocking means for any application or installation.

6. The current invention is different from all market-available LED bulbs which offer illumination that only covers an adjacent area starting from the LED Bulb to a certain distance (illumination surrounding the LED bulb) and do not offer illumination or images in areas in certain directions, angles, and distances that are faraway or remote from the LED bulb. The current invention offers any combination of nearby area illumination and faraway area illumination.

7. The current invention provides an LED bulb that may have more than one light beam output to different areas, directions, and locations, including areas that may not be adjacent, linked, or situated together. By offering illumination of more than one area, the invention allows people to save energy by providing illumination exactly where needed. For example, stair lighting only requires up-or-down two-direction illumination. Rest areas do not need light at all, and the stair-lighting may further have a built in motion sensor having sensitivity up to 10-30 feet, which is enough to cover one flight of stairs (normally is 18 steps). One light beam from an LED bulb can reach nine steps going up and one light beam from the same LED bulb can reach nine steps going down. This is enough illumination because each UP or DOWN stair are been illuminated by each floor's one LED bulb, with two different of light beams covering nine steps up and nine steps down. This provides pretty a good power saving device while the motion sensor device ensures that only one of the two light beams needs to be output from the LED bulb at any one time.

Hence, the current invention can output at least one or a plurality of light beams from one LED bulb to nearby areas, remote areas, faraway areas, or any combination of these areas with adjustable angle, adjustable focus, elastic contact points, a rotate/spin/tilt frame or support or base to obtain a desired light beam emission direction, and extendable/retractable means to install all parts and accessories away from heat or blocking means, thereby providing a lighting device that lets all light beams be emitted to areas where they are needed for illumination, unlike conventional LED bulbs that can only illuminate nearby areas which start from the LED-bulb to a certain limited distance areas (conventional LED bulbs have insufficient brightness to emit light over long distances unless an optics lens or lens assembly is provided to project light beams to remote or faraway distances which the current market items cannot accomplish).

### BRIEF DESCRIPTION OF THE DRAWINGS

FIG. 1 shows a first preferred embodiment of an LED bulb having a ball shaped unit with two arms to join with a frame (having any shape or design) to enable the ball to rotate by more than 360 degrees, with a base that is in the form of a screw base of a male type assembly that is screwed into a female receiving part for power supply.

FIG. 2 shows the manner in which the first preferred embodiment of the LED bulb emits a plurality of light beams out from the ball shape body to different areas that are far away from the LED bulb through the use of an optics lens or optics means to get a desired light performance.

FIG. 3A shows details of the construction of the first preferred embodiment of the LED bulb, including projection means, optics means, a lens, metal conductive means, a rotating frame, a rotatable base, and a screw base that enables adjustment of an angle of the LED bulb.

FIGS. 3B, 3C, 3D, 3E, 3F, 4A, FIG. 4B, and 4C show a second preferred embodiment having extend means at the front to allow some heat-sensitive parts, a motion sensor, remote controller receiver parts, blue-tooth parts, an extra LED(s), digital recording means, track means, auto moving motors means, and other electric parts and accessories to be moved so as to overcome the effects of the LED's heat or of blocking means (such as the lighting fixture's shade, curtain, cover, glass, plastic piece, wood piece, or metal piece) that might block electric signal or light beam delivery directions, the extend means having a sufficient length to overcome the heat and blocking means.

FIGS. 5A, 5B, 5C, and 5D show examples of surrounding area's blocking means that can block out a light beam or electric-signal delivery direction.

FIGS. 6A and 6B show a third preferred embodiment, including details of the LED's heat flow and the manner in which the extend means overcomes the LED's heat and blocking means, and also a rotating frame and base that allows light beams to be emitted in any direction of an x-y-z axis coordinate system without the need for an elastic contact point of the base.

FIGS. 7A, 7B, 7C, and 7D show different configurations of the LED ball for top/side/down installation so that the LED bulb(s) still can emit the light beam(s) to wherever needed. In addition, in this embodiment, any one of the LED light beams can present different light patterns by applying an adjustable focus means to one of the light beams in order to vary the size, brightness, location, distance, clearance, or even color (by adding a filter or other optics means) to the light beams.

FIGS. 8A, 8B, and 8C show an LED bulb that emits a plurality of beams, some of which have special functions such as to provide power fail lighting, auto tracking, remote control, RF transmission, infrared transmission, and blue-tooth communications,

FIGS. 9 and 10 show other embodiments which have different geometric shapes of LED bulb and different rotating constructions to enable the LED light beams to be emitted to a certain position, and elastic contact points to overcome limitations of the rotating frame, rotating arms, or rotating base design. Also, these embodiments may emit light beams having different light performance or patterns through the use of focus adjustable means.

FIGS. 11A, 11B, and 11C show a preferred embodiment which can offer nearby and remote area illumination or images at the same time. The plurality of LEDs light sources are arranged inside the projection assembly, which includes telescope means, tubular means, and extend means for remote or faraway illumination or image projection. Some of LEDs provide high power output while others provide low power output to offer nearby illumination or images comparable to those of a normal current-market LED bulb or incandescent bulb.

The current drawings are identical to those in the above-listed copending or patented applications, but with changes to the input end of the power source or power signal, so one can easily refer to the above applications for additional details of the LED bulb applications. It will be appreciated that any LED bulb concepts described in the copending or patented applications of the inventor, as well as same or equivalent-function concepts and, features may still fall within the scope of the current invention for LED bulb applications.

### DETAILED DESCRIPTION OF THE PREFERRED EMBODIMENTS

From the above background and drawing discussion, those skilled in the art will appreciate that the current invention offers a big improvement over conventional market-available LED bulbs that can only offer nearby area illumination, unlike the current invention that can use one LED bulb to offer nearby illumination, faraway illumination or image projection, or both.

Also, the current invention provides for emission of more than one light beam from LED bulb, and more than one control means for selecting the light beams for different conditions or functions, such as power failure, remote control, infrared control, blue-tooth communications with a mobile phone, and motion sensing to trigger at least one of the light beams to illuminate or project an image to selected areas.

Additional features and embodiments are as follows:

Feature 1: The LED bulb may consist of at least one LED as a light source that emits light beams to desired areas or locations with predetermined illumination, function, time period, and performance. The LED bulb may further have parts or accessories that allow for projection and adjustment, including optic means, a lens, an adjustable focus means, twist means, rotate means, an elastic contact end, more than one output light beams, a rotating frame, a bulb shade with arms for enabling rotation, a twist bulb base, support for a shade, an LED assembly, LED tubular means, adjustment means, projection means, digital data display means, LCD display means, digital camera means, data storage means, data projection optics means, sensor means, switch means, IC means, circuit means, extend means, extractable means, filter means, stencil means, cutout means, painting means, motion sensor means, remote control means, blue-tooth means, and Internet wireless means, to enable the LED bulb to emit the light beams, images, time, data, digital messages, and Internet data as desired to nearby areas or remote distance areas for illumination.

The LED bulb connects with a power source by contact means in the base to enable the LED bulb to emit light beams to areas with an adjustable angle coverage, preferably in any direction relative to an x-y-z axis coordinate system, or any combination as required for preferred light performance, effects, and functions.

Furthermore, the direction of at least one of the output light beams from the LED bulb can be adjusted to a certain area, location, distance when adjusting the above-listed component(s) of the LED bulb.

The base of the LED bulb may be in the form of male insert means to fit into the female receiving means for a desired construction.

The said LED Bulb at least has adjustable parts to enable the at least one light beam to change position, direction, or orientation.

Feature 2 The LED bulb as above listed (Feature #1), may be provided with an elastic contact means which allows the LED bulb to adjust the light beam position, location, and direction to certain areas in three dimensions.

Feature 3: The LED bulb as above listed (Feature #1) may include extendable, extractable means to enable parts to be extended away from the LED Bulb and that have a configuration and construction that allows installation of some electric parts and accessories, sensor means, motion sensor means, remote control means, heat sensitive means so as to overcome heat and the blocking effects of a lightshade, lens, curtain, glass, cover, cavity depth, or any other blocking means that might interfere with operation of the LED bulb.

Feature 4: The LED bulb as above listed (Feature #1) can incorporate optics means, an optics lens, or an optics lens assembly with parts and accessories that cause the same light beam to have different light performance.

Feature 5: The LED bulb as above listed (Feature #1), may include a focus adjustment means that enables the same light beam to present different light performances at certain locations, positions, and areas with desire brightness, size, and performance.

Feature 6: The frame and support means of the LED Bulb as above listed (Feature #1), may be arranged to enable the bulb to twist, tilt, rotate, spin, and angle-adjust e with hold means to overcome any heat issues and facilitate a change in the desired angle.

Feature 7: The base of the LED bulb as above listed (Feature #1), can have any construction including screw type, pin type, poles type, multiple pole type, twist type, and bayonet type construction.

Feature 8: The LED bulb as above listed (Feature #1) may have more than one light beam output so as to emit more than one light beam to locations, areas, and positions that are remote from the LED Bulb.

Feature 9: The LED bulb as above listed (Feature #1) may include an LED tube means that serves to prevent light leakage from the projection means and ensures that LED light beams passing through the optics means, optics lens, display unit, image forming means, LCD display, Lcos image, and/or digital display of the projection means can be emitted out of the LED Bulb to desired locations, positions, and areas.

Feature 10: The LED bulb as above listed (Feature #1) may include any of a sensor means, switch means, motion sensor means, remote control means, blue-tooth means, photo sensor means or other market-available electric parts and accessories incorporated with circuit means to cause the LED light source to emit light so as to provide predetermined light functions, performance, and effects.

Feature 11: The extension or retractable means of the LED bulb as above listed (Feature #1) can be installed with select electric parts and accessories, with the LED light source being arranged in the LED bulb in an up, down, or horizontal arrangement.

Feature 12: The LED bulb as above listed (Feature #1) can illuminate any combination of nearby or faraway areas to provide both nearby and faraway area lighting effects.

Feature 13: The LED bulb as above listed (Feature #1) may have more than one function that not only offers illumination for nearby areas or remote distance areas, but that also may incorporate motion sensor, remote control, blue-tooth, and other functions.

Feature 14: The extendable and retractable means of the LED bulb may include any heat-sensitive or light blocking-means-affected circuit means, IC means, electric parts and accessories, switch means, sensor means, remote control means, blue-tooth means or equivalent trigger means, extra LEDs, RF receiving means, IR sensor means, or other control means to overcome the effects of the LED's heat or surrounding blocking-means such as a lighting fixture's shade, cover, glass, frame, support, ceiling, wood piece, metal piece, or plastic pieces. The extend means can extend to a certain distance away from the LED's heat or any blocking-means so that the blocking means will not interfere with delivery of the light beams or electric signal delivery direction that might affect the pre-determined functions, performances, and effects of the LED bulb.

Feature 15: The LED bulb may include angle, position, orientation, direction, or focus-adjust means incorporated with optics means, an optics lens, a projection assembly, or an LED assembly. The LED bulb emits the light beam to desire areas in a preferred combination of nearby illumination, faraway illumination, nearby image projection, or faraway image projection, the projection including projection of a digital data image, movie image, internet digital data image, time display, motion picture image, or colorful image.

Feature 16: The LED light beam of the preferred LED bulb may further be triggered by control means which may be selected from one or more of a motion sensor, remote control, infrared sensor, blue-tooth means, power failure means and built-in direct current power storage means, sensor means, switch means, or other electric parts and accessories.

The following detailed description of the drawings include subject matter that was originally included as notes in the original drawings:

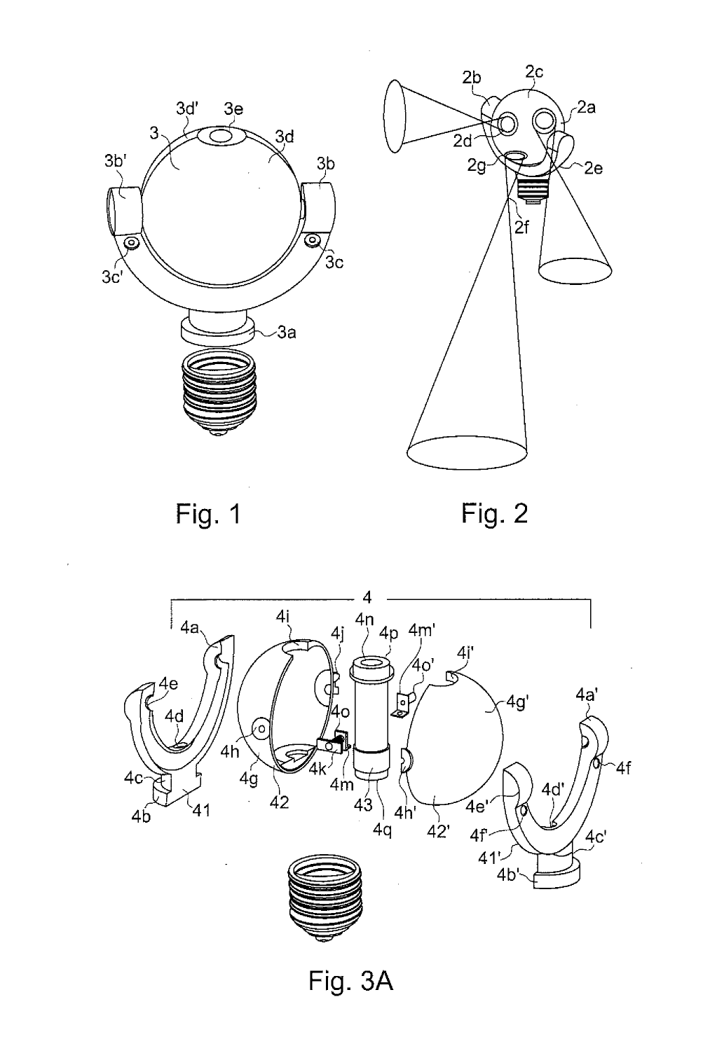

FIG. 1 shows a first preferred embodiment of the LED bulb of the invention having a ball-shaped unit with two arms to join with a frame (preferred any shape design) to enable the ball to rotate by more than 360 degrees in order to adjust a projection angle.

The base is in a form of a screw base of male type for assembly with female receiving parts that supply power.

FIG. 2 shows the manner in which the LED bulb of the first preferred embodiment emits light from the ball shape body to different areas far away from the LED bulb using an optics lens and optics means to help get a desired light performance.

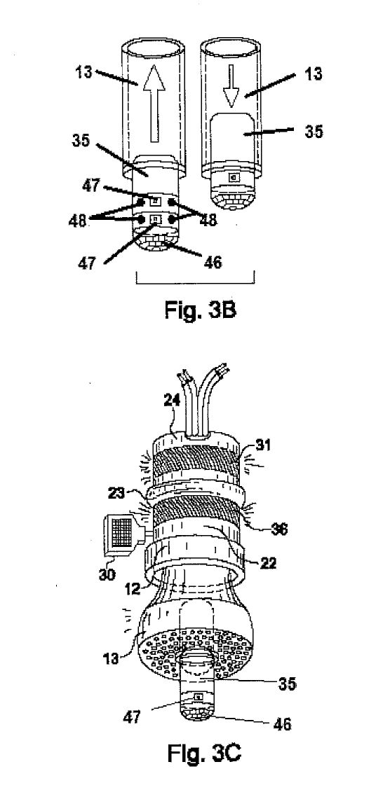

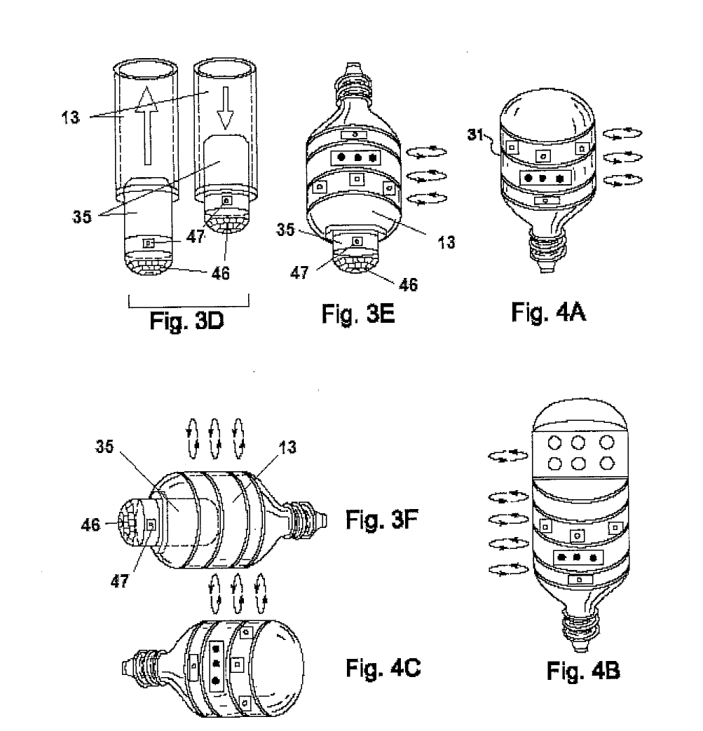

FIG. 3 shows further details of the first preferred embodiment, including project means, optics means, lens, metal conductive means, a rotating frame, rotatable base, and a screw base to enable adjustment of the angle at which light beams are emitted by the LED bulb.

FIGS. 3A, 3B, 3C, 3D, 3E, 4A, and 4B show a second preferred embodiment having extendable and retractable means 35 in front to allow some heat-sensitive parts such as a motion sensor, remote controller receiver, or blue-tooth means 46, camera(s) 47, other sensor(s) 48, or extra LED(s), digital recording means, track means, auto moving motors means or other preferred electric parts and accessories (Not shown) to be installed within and moved to overcome the effects of the LED's heat or the effects of blocking-means 13 such as a lighting fixture's shade, curtain, cover, glass, plastic piece, wood piece, metal piece that would otherwise block an electric signal or light beam delivery direction. As shown in FIG. 3B, the blocking-means 13 is in the form of an LED bulb cover, which is plugged into a socket 12 including additional illuminating elements 31 and 36, sensor means 30, and rotatable housing elements 22 and 24.

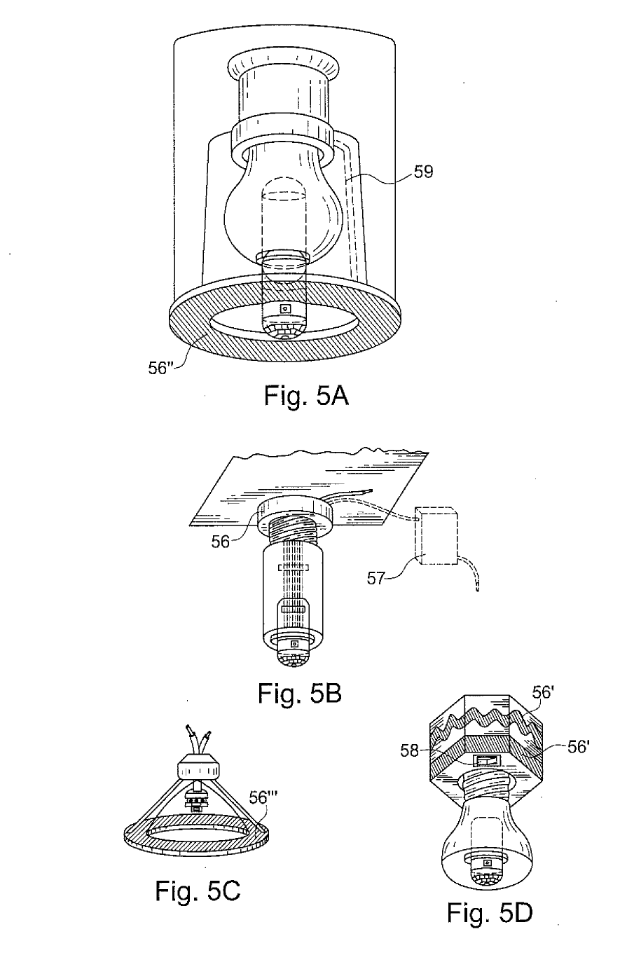

FIGS. 5A, 5B, 5C, and 5D show examples of some of the surrounding area's blocking-means that will block light beam or electric-signal delivery direction, and that can be overcome by the extend means of the preferred embodiment.

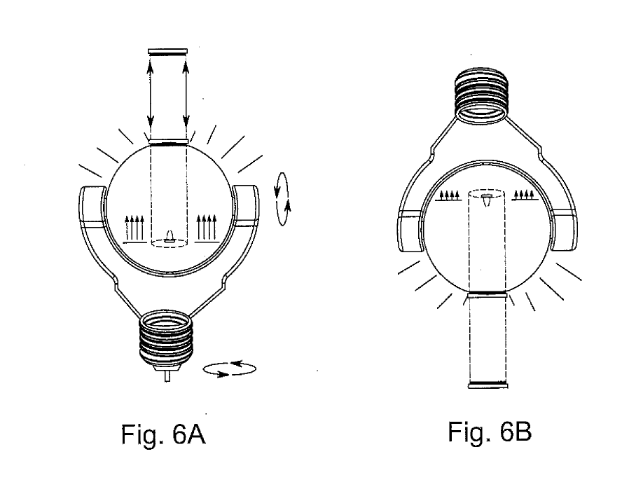

FIGS. 6A and 6B show a third preferred embodiment which shows details of the LED's heat flow and the manner in which the extend means overcome the LED's heat flow and the effect of blocking-means, as well as a rotating frame and base that allow the light beams to be emitted to any direction in three dimensions without any problem, or even the need for an elastic contact point of the base.

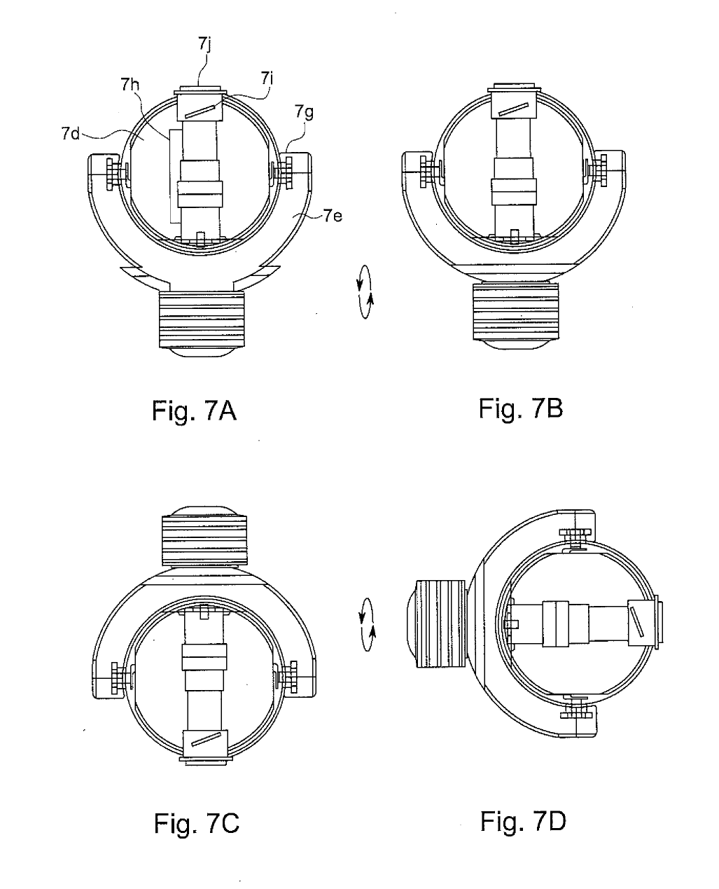

FIGS. 7A to 7D show different installations of the LED ball in top/side/down orientations so that the LED Bulb(s) still can emit light beam(s) to wherever needed. Other features are that any one of the LED light beams can present different light pattern(s) while apply the adjustable focus means can have a different light performance, including different size, brightness, location, distance, clearance, or even color when adding a filter or other optics means.

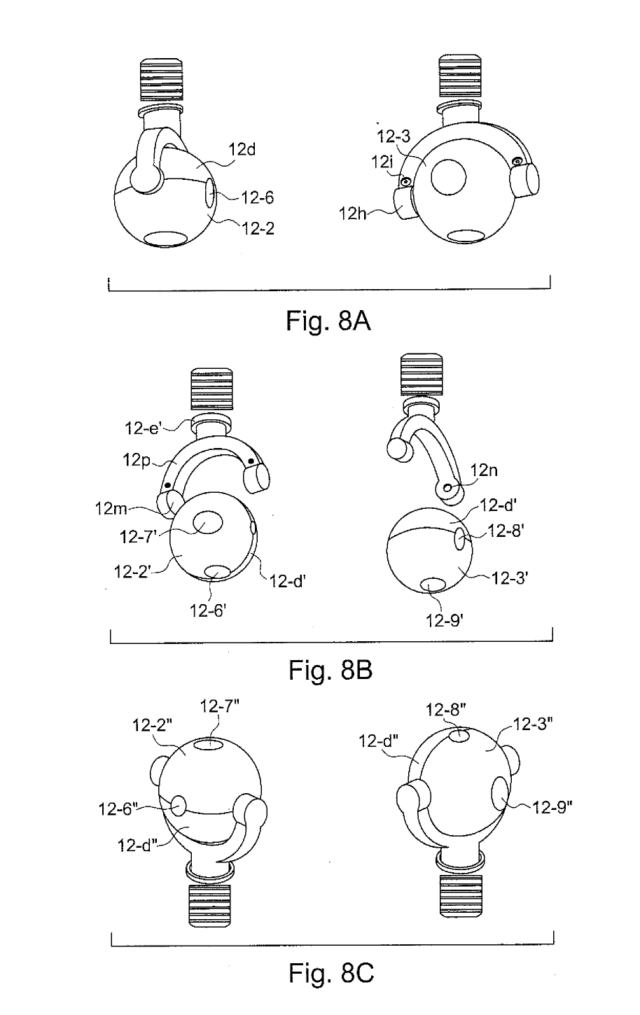

FIGS. 8A to 8C show an LED bulb from which a plurality of light beams are emitted, with different LED light beams having special functions such as a power fail illumination function, auto tracking, remote control, RF transmission/reception, infrared emission, blue-tooth communications, and so forth.

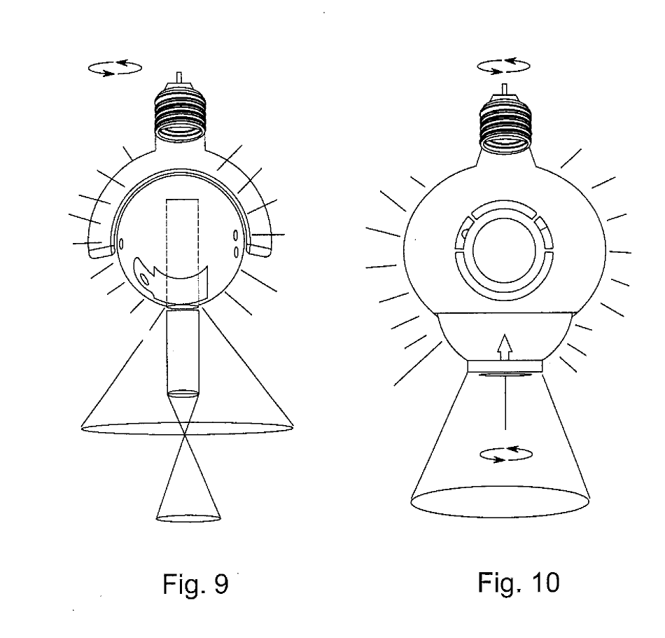

FIGS. 9 and 10 show other embodiments which have different geometric shapes of LED bulb and different rotating construction to cause the LED light beams to be emitted to a certain position and elastic contact points to help overcome limitations of the rotating frame, rotating arms, and rotating base design. Focus adjustment means enable one light beam to have different light performance or patterns.

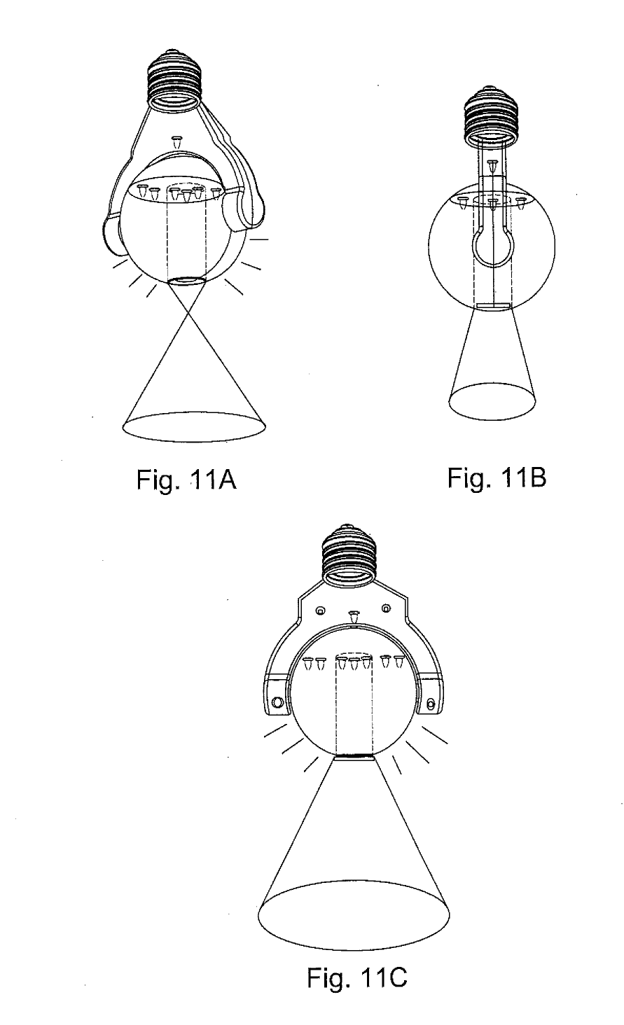

FIGS. 11A to 11C show a preferred embodiment which can offer nearby and remote area illumination or images at the same time. The plurality of LED light sources are arranged inside the projection assembly, telescope means, tubular means, and extend means and projected to provide the remote or faraway illumination or image. Some of LEDs have a high power output while others have a low power output to offer the nearby illumination or images comparable to those of a conventional LED bulb or incandescent bulb. Hence, the current invention can use one single LED bulb to provide more than one area with illumination or images.

I claim:

1. An LED bulb, comprising: at least a first LED and a second LED;
Projection assembly means for projecting light beams or images from the first LED to a remote area, the projection assembly means including optical elements and a lens for projecting or create the Big light beams patterns or image from the first LED to the remote area, and at least one of a tube or tube-like housing to prevent light beam leakage out, and a display unit, the display unit which including an image or pattern forming element, a display forming device, Slide, film, printed piece, digital data display or LCD display, to project the light beams image, message, time, geometrie image, arts, movie, moving articles or any desired visible items, things to project the or create the lighted pattern, images, message, time, geometric image, arts, movie, moving articles with motor or movement device, OR-and create the light pattern or-and image while the light beam passing though steady or moving optic-lens(es) which has reflective or-and refractive properties to create steady or-and moving lighted patterns image, any desired visible effects.
wherein the light beams from said second LED are emitted or projected to a nearby area or to a second remote area;
movable construction means for moving housing components that are sensitive to heat or whose operation is vulnerable to interference from light traveling or electric-signal transmitting blocking elements so can stay away from the heat or away from the light or away from signal blocking elements;
position, orientation or angle adjustment device or kits means supply functions for adjusting a position, orientation or angle of said light beams or lighted patterns projected or traveled to the desired remote area from the first LED; and
a base insertable into a lamp holder for connected connecting the LED bulb to a power source.

2. An LED bulb as claimed in claim 1, further comprising elastic contact construction means that enable the LED bulb to be rotated upon insertion into the lamp holder to adjust a direction of the light beam in three dimensions.

3. An LED bulb as claimed in claim 1, further comprising optics element(s) means for varying a light performance of a light beam emitted by the LED bulb.

4. An LED bulb as claimed in claim 3, wherein the optics element(s) means is a focus adjustment kit means for adjusting a focus of the light beams from the first LED or other adjustment controller(s) to vary a brightness, size, colors changing and performance of the light beams at desired locations or areas.

5. An LED bulb as claimed in claim 1, wherein the base is a screw type, pin type, pole type, multiple pole type, twist type, or bayonet type light bulb base.

6. An LED bulb as claimed in claim 1, wherein the LED bulb emits more than one set of light beams to locations, areas, and positions away or surrounding from the LED Bulb.

7. An LED bulb as claimed in claim 1, wherein the tube or tube-like housing of the projection assembly means prevents light leakage from the projection assembly or LED Bulb housing means and ensures that LED light beams passing through desired combination of the optical elements, lens, and display unit, image forming sets means, LCD display, Leos image, LCOS lens, and/or digital display of the projection assembly means are emitted out of the LED bulb to desired locations, positions, and areas has desired light, lighted patterns, colors or color changing, moving images or changeable images as predetermined functions, performance, effects.

8. An LED bulb as claimed in claim 1, further comprising any of a sensor, switch, motion sensor, remote control, blue-tooth unit, Wifi unit, and photo sensor incorporated with circuitry for causing at least one of the first or-and second LEDs or-and both or-and more LEDs to emit light so as to provide predetermined light functions, performance, and effects.

9. An LED bulb as claimed in claim 1, wherein the movable construction means of the LED bulb is arranged in the LED bulb in an top or end up, dw m, or horizontal or any desired arrangement is extendable or retractable in a predetermined direction.

10. An LED bulb as claimed in claim 1, wherein the LED bulb not only offers provides illumination for nearby areas and remote areas, but also incorporates additional functions including one of a motion sensor, remote control, blue-tooth, and wifi function.

11. An LED bulb, comprising: at least one LED;
at least one of movable construction means for housing components that are sensitive to heat from the at least one LED or whose operation is vulnerable to interference from light traveling or electric signal delivery blocking elements, said the movable construction means being movable to move the housing or parts or components stay away from the heat or stay away from the light traveling block objects or stay away electric signal blocking elements so that they do not interfere with operation of the components, light functions, project patterns performance, project image, light beams traveling direction; light functions, performance, project image, light beams traveling directions; and
a base insertable into a lamp holder for connecting the LED bulb to a power source.

12. An LED bulb, comprising: at least a first LED and a second LED;
Projection assembly means for projecting Big light patterns or images from the first LED to a remote area, the projection assembly means including optical elements and at least one lens for projecting the light beams patterns or images from the first LED to the remote area, and at least one of a tube or tube-like housing to prevent light leakage out, and display unit through which light beams from the first LED pass before being projected-out or existed by the lens, the display unit including an image or pattern forming element, digital data display, or LCD display, Slide, film, printed piece, optics-lens(es) has reflective or-and refractive function for forming said light beam patterns or images, parts & accessories incorporated with the said 1st or-and 2nd LED including motor, stencil, windows.
wherein light beams from said at least one of second LED are emitted light or projected or illuminated to a desired nearby area or to at least one second remote area or more than one of the said area; and
a base insert into a lamp holder for connecting the LED bulb to a power source; and
The bulb has at least one of circuitry including one of a switch, sensor, blue tooth unit, or remote control or wireless controller unit.

13. An LED bulb, comprising: at least one LED;
at least one of the moving construction means for moving, extending, or retracting components, parts or accessories that are sensitive to heat from the at least one LED or whose operation is vulnerable to interference from light traveling or signal blocking elements,
wherein said the light or signal blocking elements include one of a lamp shade metal frame, Lamp shade is a glass material, a light inside a deep recess hole traveling block piece, a blocking material, and electric signal blocking elements, and wherein the moving construction to means moves the components, parts, or accessories stay away from the heat or the light traveling or electric signal blocking elements so that the heat or the light traveling or electric signal blocking elements do not interfere with operation of the components, parts, or accessories and can get good light functions, electric signal performance, project image, design lighted pattern(s) projection, or light beam traveling functions, performance, project image erojeetioa light beams traveling; and
a LED bulb has base insert into a lamp holder or connecting the LED bulb to a power source.

14. An LED bulb, comprising:
at least a first LED and a second LED;
The said at least one of 1st LED is white color to project or offer illumination for desired areas.
The said at least one of 2nd LED is multiple color LEDs to project or offer illumination for the desired areas with the remote controller, wifi controller, blue tooth controller to get the desired colors of automatically color changing or desired light functions.
The said White Color or multiple colors LEDs can control by wireless controller.
a base insert into a lamp holder for connecting the LED bulb to a power source,; _and
LED bulb has at least one of circuitry, sensor, IC (integrated Circuit), blue tooth unit, or remote control or wireless controller unit.

15. An LED bulb, comprising:
at least one of LED;
The said at least one of LED is white color to project or-and offer illumination for desired or offer multiple color or color changing Light functions to desired areas.
The said White Color Light beams or multiple colors LEDs can control by wireless controller.
The said LED Bulb has at least one of built-in or add-on flexible hose, bendable tube-like arm, snake hose, bendable bar has bulb-socket and bulb-base on ends so can change the LED bulb light emitting direction or overcome any block-elements to get desired light emit direction, good electric-signal receiving.
a base insert into a lamp holder for connecting the LED bulb to a power source;_and
The LED bulb has at least one of circuitry, sensor, IC (Integrated circuit), blue tooth unit, or remote control or wireless controller unit.
